(19) United States
(12) Patent Application Publication
(10) Pub. No.: US 2026/0208677 A1
(43) Pub. Date: Jul. 23, 2026

(54) VEHICLE CONSOLE HAVING STOWABLE LID

(71) Applicant: Ford Global Technologies, LLC, Dearborn, MI (US)

(72) Inventors: Luis Ángel López Cedillo, Mexico City (MX); Carlos Torner Campuzano, Mexico City (MX); Juan Jose Perez Vargas, Cuautitlán Izcalli (MX)

(73) Assignee: Ford Global Technologies, LLC, Dearborn, MI (US)

(21) Appl. No.: 19/033,777

(22) Filed: Jan. 22, 2025

(51) Int. Cl. B60R 7/04; B60N 3/00

(52) U.S. Cl. CPC B60R 7/04; B60N 3/002

(57) ABSTRACT

A vehicle console may include a housing having sidewalls defining a storage compartment and a top access opening, a lid coupled to the housing via a pair of pivot brackets and moveable between a closed position covering the top access opening and an open position exposing the side top access opening. A pair of rails are provided on the lid. A pair of slide are coupled to one end of the pair of pivot brackets and engaged within the pair of rails configured to allow the lid in the open position to slide from an upward vertical position to a downward stowed position.

### FIELD OF THE DISCLOSURE

The present disclosure generally relates to vehicle consoles, and more particularly relates to a console having a lid that is stowable and/or deployable into a work tray for a vehicle.

### BACKGROUND OF THE DISCLOSURE

Motor vehicles are commonly configured with a cabin interior having passenger seating and one or more consoles providing cargo storage space. For example, a center console is typically installed centrally between the driver and passenger seats in the front row of seating in a vehicle. It would be desirable to provide for a vehicle console having a lid that may be stowed and/or used as a work table.

### SUMMARY OF THE DISCLOSURE

According to a first aspect of the present disclosure, a vehicle console may include a housing having sidewalls defining a storage compartment and a top access opening, a lid coupled to the housing via a pair of pivot brackets and moveable between a closed position covering the top access opening and an open position exposing the side top access opening. A pair of rails are provided on the lid. A pair of slide are coupled to one end of the pair of pivot brackets and engaged within the pair of rails configured to allow the lid in the open position to slide from an upward vertical position to a downward stowed position.

Embodiments of the first aspect of the present disclosure can include any one or a combination of the following features:
the pair of slide elements includes first and second T-shaped slides;
the pair of rails include first and second rails, each having a T-shaped opening for receiving the corresponding first and second T-shaped slides;
the pair of pivot brackets is coupled to the housing via a pivot pin;
the pair of pivot brackets each have a curved shape;
a friction contact member spring biased between one of the pair of rails and one of the pair of slides;
the pair of rails are located in a bottom side of the lid;
the lid comprises a deployable table having a first table and a second table, wherein the first table member folds onto the second table member in a stowed position and pivots about a hinge to an open position;
the second table extends reward of the first table;
a latch connector for connecting the lid to the housing in the closed position; and
the vehicle console is a center console.

According to a second aspect of the present disclosure, a vehicle center console may include a housing having sidewalls defining a storage compartment and a top access opening and a lid coupled to the housing via a pair of pivot brackets. The pivot brackets are moveable between a closed position covering the top access opening and an open position exposing the top access opening. The pair of pivot brackets are pivotable coupled to the housing. A pair of rails are provided on the bottom of the lid. A pair of slide elements are coupled to one end of the pair of pivot brackets and engaged within the pair of rails configured to allow the lid in the open position to slide from an upward vertical position to a downward stowed position.

Embodiments of the second aspect of the present disclosure can include any one or a combination of the following features:
the pair of slide elements includes first and second T-shaped slides;
the pair of rails include first and second rails, each having a T-shaped opening for receiving the corresponding first and second T-shaped slides;
the pair of pivot brackets is coupled to the housing via a pivot pin;
a friction contact member spring biased between one of the pair of rails and one of the pair of slides;
the pair of pivot brackets each have a curved shape;
the lid comprises a deployable table having a first table and a second table, wherein the first table member folds onto the second table member in a stowed position and pivots about a hinge to an open position;
the second table extends reward of the first table; and
a latch connector for connecting the lid to the housing in the closed position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a upper side perspective view of a front portion of a cabin interior of a motor vehicle having a center console configured with a lid shown deployed in a closed position;

FIG. 2 is an upper perspective view of the center console having the lid shown deployed in the closed position;

FIG. 3A is a cross-section taken through line IIIA-IIIA of FIG. 2 illustrating the lid configured with a folded table and a release button in connected position;

FIG. 3B is a cross-sectional view taken through line IIIA-IIIA of FIG. 2 showing the release button in a depressed disconnected position;

FIG. 4 is an upper side perspective view of the vehicle console illustrating the lid deployed in a partially unfolded table position;

FIG. 5 is an upper side perspective view of the vehicle console illustrating the lid deployed in a fully deployed table position;

FIG. 6 is a cross-sectional view taken through line VI-VI of FIG. 5 illustrating the lid retainer engaged with the lid in the closed position;

FIG. 7 is an upper perspective view of the vehicle console with the lid in the closed position;

FIG. 8 is an upper perspective view of the vehicle console with the lid in a partially open position;

FIG. 9 is an upper perspective view of the vehicle console with the lid deployed in a fully open position with the lid elevated;

FIG. 9A is an enlarged partial cutaway view of section IXA of FIG. 9 further illustrating the lid supporting pivot bracket and sliding rail mechanism; and

FIG. 10 is an upper perspective view of the vehicle console illustrating the lid in an open and stowed position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

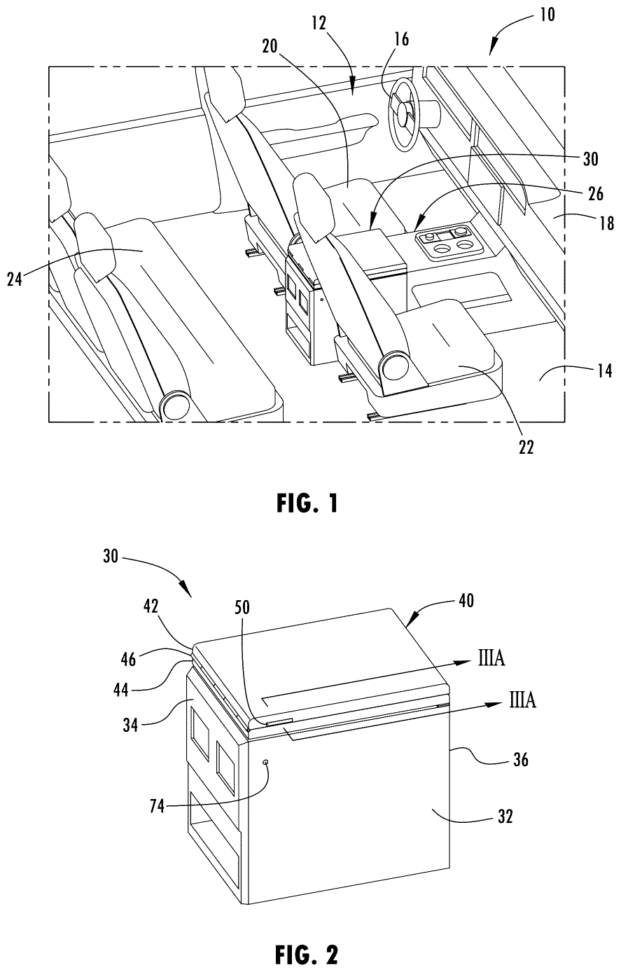

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle console having a stowable lid. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a wheeled automotive or motor vehicle 10 is generally illustrated configured with passenger seating and accommodations for transporting one or more passengers including a driver of the vehicle 10 and cargo items. The motor vehicle 10 has a vehicle body that generally defines a cabin interior 12. The cabin interior 12 may contain various features and trim components within the vehicle body. The cabin interior 12 is shown having an arrangement of passenger seats including a first driver's seat 20 and a second passenger seat 22 which may be configured as captain seats, for example, arranged as a front row of seats. The vehicle 10 is also shown having a second row of seating 24 located rearward of the first and second seats 20 and 22. The motor vehicle 10 may also include further seating such as a third row or further rows of seating as is common for typical large SUVs, vans or buses. It should be appreciated that the motor vehicle 10 may be a motor vehicle such as a wheeled car, truck, SUV, van or bus, for example, or an airplane, train, boat or other vehicle capable of transporting one or more passengers.

The motor vehicle 10 is illustrated having the driver's seat 20 located rearward of a steering wheel assembly 16 and a front dashboard 18 that generally defines an interior trim portion of the cabin interior 12 which is generally vehicle-rearward of a front windshield. The dashboard 18 may include various trim panel components and electronics, e.g., instruments, and may also be referred to as an instrument panel. Located vehicle-forward of the driver's seat 20 and generally extending rearward of the dashboard 18 is the steering wheel assembly 16 which has a steering column and steering wheel configured to be engaged by a driver seated in the driver's seat 20 and rotated to steer the direction of steerable vehicle road wheels and hence steer the motor vehicle 10.

The driver's seat 20 is illustrated located in the front seating row on one lateral side of the cabin interior 12 of the motor vehicle 10 proximate to a driver's side entry door. The passenger seat 22 is illustrated located in the front seating row on the opposite lateral side of the cabin interior 12 proximate to a passenger side entry door. The driver seat 20 and passenger seat 22 may each include a seat base and seat back and are supported by an underlying floor 14. Located between the front row driver's seat 20 and the front row passenger seat 22 is a vehicle console in the form of a center console 30, according to one example. The center console 30 is generally supported on the underlying floor 14 and generally consumes the space between the front row driver's seat 20 and the front row passenger seat 22. The center console 30 may include a forward portion 26 that extends generally forward towards and may extend up to the dashboard 18 which may include various vehicle input control devices such as control knobs and cup holders, for example.

The center console 30 is generally illustrated as an armrest style center console having a lid that provides a cover over a storage compartment and an armrest and has a built-in foldable table and is generally supported by the underlying vehicle floor 14 on the bottom side thereof and disposed between the driver's and passenger seats 20 and 22. The center console 30 provides an armrest surface on the top side in the closed position which may include a cushion for supporting either the driver or passenger arms. The center console 30 also may be converted to a foldout table configuration with a top work surface.

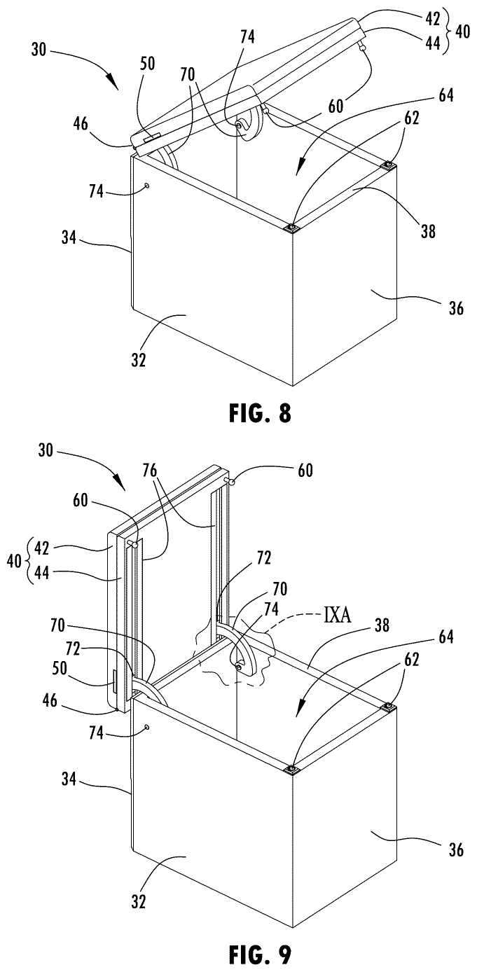

Referring to FIG. 2, the center console 30 is further illustrated having a housing 32 which may include lateral sidewalls, a front wall 36 and a rear wall 34. The housing 32 generally defines a storage compartment that has a top access opening 38 on the top as shown in FIG. 8. The center console 30 has a lid 40 that is configured to cover the top access opening 38 when oriented in the closed position and to expose the top access opening 38 when oriented in the open position. It should be appreciated that the housing 32 generally defines the storage compartment 64 which can be accessed via the top access opening 38 for storing one or more cargo items, for example.

The lid 40 has a foldout table with upper and lower tables 42 and 44 which are hingedly connected together along abutting edges via hinge 46. The hinge 46 is configured to allow the upper and lower tables 42 and 44 to pivot relative to each other between a folded table arrangement and an unfolded table arrangement. The lid 40 is configurable as a folded table that unfolds to a deployed table configuration as shown in FIG. 5. The lid 40 has the upper first table 42 which folds onto the lower second table 44 in the stowed position. In the use position, the first upper table rotates about hinge 46 one hundred eighty degrees (180°) to a rearward deployed position as shown in FIG. 5 which provides an enhanced surface area for a top work surface that may hold a work device, for example, such as a computer 100. The hinge 46 has an end-of-travel limit that prevents the first table 42 from rotating beyond the 180 degrees fully extended arrangement.

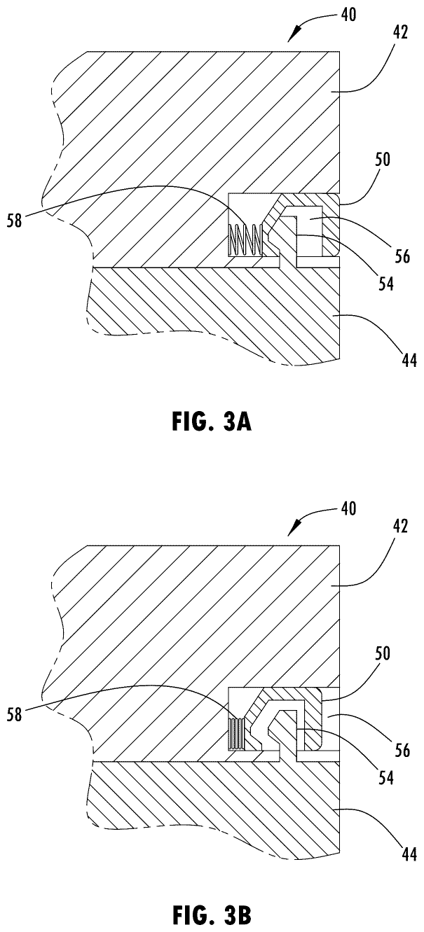

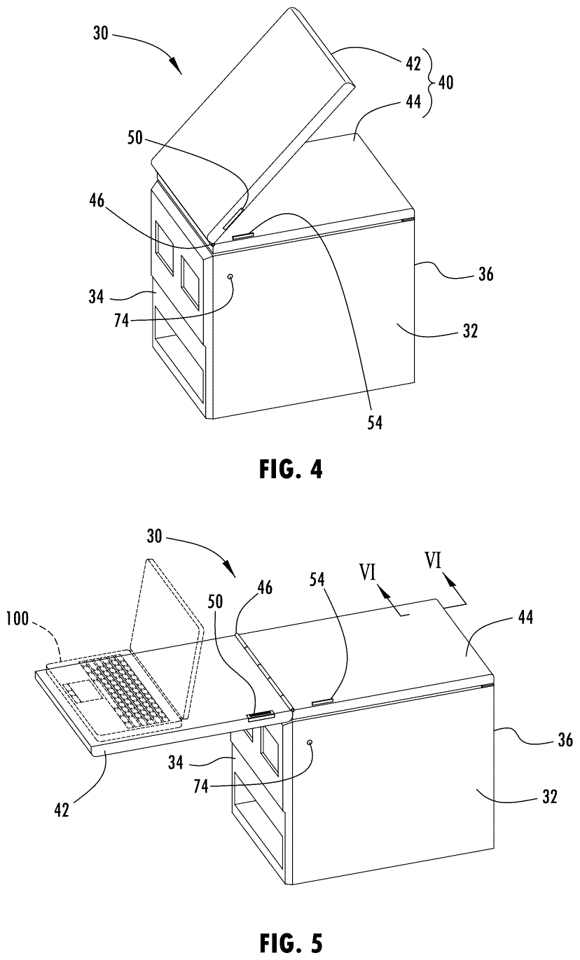

To deploy the work table from the stowed folded position to the unfolded use position, a user may depress a release button 50 provided in one or both sidewalls of the lid 40 to release a connection of the first table 42 with the second table 44. As seen in FIGS. 3A and 3B, the release button 50 is spring biased via spring 58 to an outward position that latches a tooth 54 of the second table 44 within a recess 52 of the first table 42 in the converted latched position. When a user presses with force inward on the release button 50, the recess 52 moves against the spring 48 to an open unlatched position to allow the tooth 54 to be released within opening 56 to thereby allow the first table 42 to separate from the second table 44 and rotate 180 degrees by force applied by a user to the unfolded use position. It should be appreciated that the first table 42 may be folded back upon the top of the second table 44 and relatched with the release button 50 to hold the lid 40 together as a unitary unit.

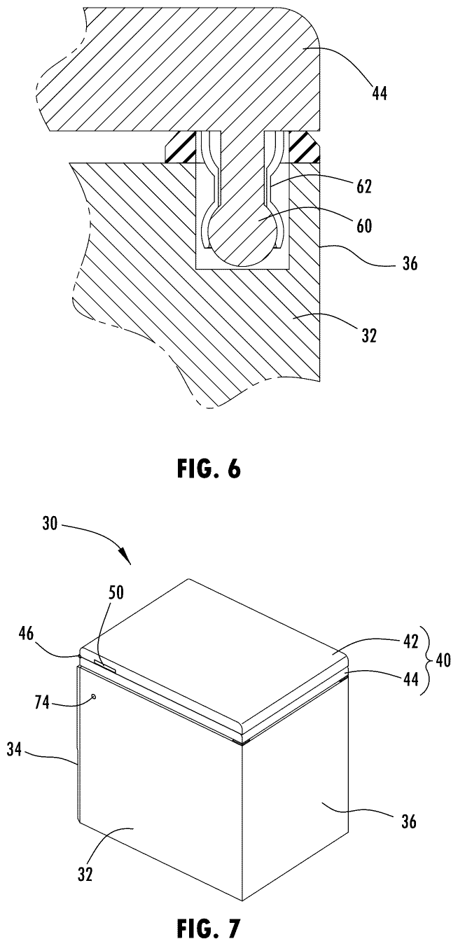

Referring to FIG. 6, the lid 40 has a pair of latch connectors 60 provided on the front end in the lower second table 44 that extend downward aligned to connect to the housing 32. Each latch connector 60 is configured as a spherical ball member configured to engage within a resilient spherical receiver 62 in housing 32 to retain the lid 40 onto the housing 32 to hold the lid 40 in the closed position. A user may pull upward on lid 40 with sufficient force to release the spherical latch connector 60 to disconnect the spherical latch connector 60 from the spherical receiver 62 to allow the lid 40 to release and pivot upward. It should be appreciated that one or more latch connectors may otherwise be configured to retain the lid 40 in the closed position.

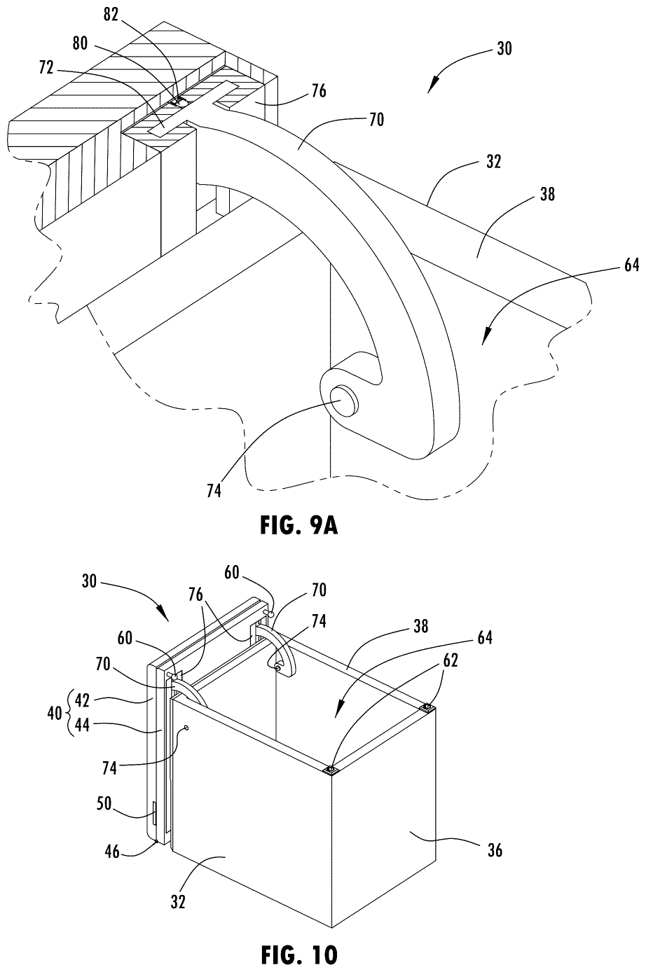

The vehicle console 30 is shown in FIG. 7 with the lid 40 in the closed position and the table folded into the stowed configuration. The lid 40 may be disengaged from the front end of the housing 32 by releasing the spherical connector latches 60 from the receiver 62 and rotated upward and rearward as shown in FIG. 8, and may be further rotated upward to a fully open vertical position as shown in FIG. 9. In the fully open vertical position, the lid 40 is fully open to expose the top access opening 38 and hence the storage compartment 64.

The lid 40 has a pair of curved pivot brackets 70 on opposite lateral sides that allow the lid 40 to pivot about a rear end of the housing 32. The pivot brackets 70, which are shown in more detail in FIGS. 9, 9A and 10, are connected to the housing 32 via a pair of pivot pins 74 at one end and a pair of the T-shaped rails 76 at the opposite end. Each pivot bracket 70 has an arcuate shape extending from the corresponding pivot pin 74 to the opposite end which has a T-shaped slide 72 that is configured to engage a T-shaped rail 76 in the underside of the lid 40. The T-shaped rails 76 each extend longitudinally along the bottom of the lid 40 near opposite sides. The T-shaped slide 72 is configured to moveably slide within rail 76 to adjust the position of the lid 40 between the upward extending position shown in FIG. 9 and a downward stowed position shown in FIG. 10. This enables the lid 40 to be moved to the stowed downward position as shown in FIG. 10 in which the lid 40 is lowered to allow access to the storage compartment 64 from the rear end of the vehicle console 30, particularly for passengers that might be seated in the rear or second row of seating. As such, the lid 40 may be lowered to the stowed out-of-the-way position to prevent blocking forward viewing and access to the storage compartment 64 for rear seated passengers.

Each rail 76 is further configured to include a spherical contact head 80 which is spring biased via a spring 82 to frictionally hold the T-shaped slide 72 and hence the lid 40 in the upper elevated position. A user may simply apply sufficient force downward to overcome the spring bias of spring 82 to slide past the spherical head 80 to allow the T-shaped slide 72 to slide downward on rail 76 and thereby move the lid 40 to the downward stowed position. The stowed lid may be moved back upwards to the extended open position shown in FIG. 9 by applying force to pull the lid 40 upwards, and the lid 40 may be then rotated to the closed position.

Accordingly, the vehicle console 30 advantageously is equipped with a multi-functional console lid assembly that conveniently stows the lid 40 in a position to allow enhanced viewing and access to the storage compartment 64, particularly for users seated rearward of the vehicle console 30. Additionally, the lid 40 advantageously is deployable as a foldout table to provide for a work surface with an enhanced size surface area.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle console comprising:
a housing having sidewalls defining a storage compartment and a top access opening;
a lid coupled to the housing via a pair of pivot brackets and moveable between a closed position covering the top access opening and an open position exposing the side top access opening;
a pair of rails provided on the lid; and
a pair of slide elements coupled to one end of the pair of pivot brackets and engaged within the pair of rails configured to allow the lid in the open position to slide from an upward vertical position to a downward stowed position.

2. The vehicle console of claim 1, wherein the pair of slide elements includes first and second T-shaped slides.

3. The vehicle console of claim 2, wherein the pair of rails include first and second rails, each having a T-shaped opening for receiving the corresponding first and second T-shaped slides.

4. The vehicle console of claim 1, wherein the pair of pivot brackets is coupled to the housing via a pivot pin.

5. The vehicle console of claim 1, wherein the pair of pivot brackets each have a curved shape.

6. The vehicle console of claim 1, further comprising a friction contact member spring biased between one of the pair of rails and one of the pair of slides.

7. The vehicle console of claim 1, wherein the pair of rails are located in a bottom side of the lid.

8. The vehicle console of claim 1, wherein the lid comprises a deployable table having a first table and a second table, wherein the first table member folds onto the second table member in a stowed position and pivots about a hinge to an open position.

9. The vehicle console of claim 8, wherein the second table extends reward of the first table.

10. The vehicle console of claim 1, further comprising a latch connector for connecting the lid to the housing in the closed position.

11. The vehicle console of claim 1, wherein the vehicle console is a center console.

12. A vehicle center console comprising:
a housing having sidewalls defining a storage compartment and a top access opening;
a lid coupled to the housing via a pair of pivot brackets and moveable between a closed position covering the top access opening and an open position exposing the top access opening, wherein the pair of pivot brackets are pivotable coupled to the housing;
a pair of rails provided on the bottom of the lid; and
a pair of slide elements coupled to one end of the pair of pivot brackets and engaged within the pair of rails configured to allow the lid in the open position to slide from an upward vertical position to a downward stowed position.

13. The vehicle center console of claim 12, wherein the pair of slide elements includes first and second T-shaped slides.

14. The vehicle center console of claim 13, wherein the pair of rails include first and second rails, each having a T-shaped opening for receiving the corresponding first and second T-shaped slides.

15. The vehicle center console of claim 12, wherein the pair of pivot brackets is coupled to the housing via a pivot pin.

16. The vehicle center console of claim 12, further comprising a friction contact member spring biased between one of the pair of rails and one of the pair of slides.

17. The vehicle center console of claim 12, wherein the pair of pivot brackets each have a curved shape.

18. The vehicle center console of claim 12, wherein the lid comprises a deployable table having a first table and a second table, wherein the first table member folds onto the second table member in a stowed position and pivots about a hinge to an open position.

19. The vehicle center console of claim 18, wherein the second table extends reward of the first table.

20. The vehicle center console of claim 12, further comprising a latch connector for connecting the lid to the housing in the closed position.
